(19) United States
(12) Patent Application Publication
(10) Pub. No.: US 2008/0025056 A1
(43) Pub. Date: Jan. 31, 2008

(54) POWER FACTOR CORRECTION CIRCUITS

(75) Inventor: Chuan-Chu CHEN, Taoyuan City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/782,603

(22) Filed: Jul. 24, 2007

(30) Foreign Application Priority Data
Jul. 31, 2006 (TW) TW95127953

(51) Int. Cl. H02M 7/217

(52) U.S. Cl. 363/80; 315/247

(57) ABSTRACT

Power factor correction circuits are provided, in which a boosting converter comprises a switching element and an inductor, to convert a rectified voltage to a DC output voltage. An adjustment unit comprises a thermister with positive temperature coefficient, to generate an adjustment signal according to a present temperature and the DC output voltage. A control unit controls a duty cycle of the switching element according to the adjustment signal, thereby adjusting the voltage difference between the rectified voltage and the DC output voltage.

### BACKGROUND OF THE INVENTION

1. Field of the Invention

The invention relates to a power supply circuit, and in particular to a power supply circuit applied to projectors.

2. Description of the Related Art

Conventional display apparatus, such as cathode-ray tube (CRT) or liquid crystal displays (LCD), can only provide an image up to 30 40 inches wide and are inconvenient to transport. Projectors, capable of outputting an image up to tens or hundreds inches wide and is much smaller, easily outperforms both CRT display and LCD in terms of entertainment or business.

Conventional projectors each comprise a power factor correction circuit to provide a fixed DC voltage regardless of temperature to a DC/DC converter and an igniter. Because the majority of power is provided by the power factor correction circuit, thermal design challenges can be reduced if the efficiency of the power factor correction circuit is improved and loss reduced.

### BRIEF SUMMARY OF THE INVENTION

Embodiments of a power factor correction circuit are provided, in which a boosting converter comprises a switching element and an inductor, to convert a rectified voltage into a DC output voltage. An adjustment unit comprises a thermister with positive temperature coefficient, to generate an adjustment signal according to a present temperature and the DC output voltage. A control unit controls a duty cycle of the switching element according to the adjustment signal, thereby adjusting the voltage difference between the rectified voltage and the DC output voltage.

The invention provides another embodiment of a power factor correction circuit, in which a boosting converter comprises a switching element and an inductor, to convert a rectified voltage into a DC output voltage according to a formula of

$$Vo = \frac{1}{( 1 - D ( t ) )} \times V ( t ) .$$

V(t) represents the rectified voltage, Vo represents the DC output voltage and D(t) represents a duty cycle of the switching element. A voltage division circuit comprises a thermister with positive temperature coefficient, to generate an adjustment signal according to a present temperature and the DC output voltage. A control unit shortens the duty cycle of the switching element thereby lowering the DC output voltage when the temperature of the switching element or the inductor increases, according to the adjustment signal.

The invention provides an embodiment of a projector comprising the disclosed power factor correction circuit, a lamp and an igniter lighting the lamp.

### BRIEF DESCRIPTION OF THE DRAWINGS

The invention can be more fully understood by reading the subsequent detailed description and examples with references made to the accompanying drawings, wherein:

FIG. 1 shows an embodiment of a projector; and

FIG. 2 shows an embodiment of a power factor correction circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

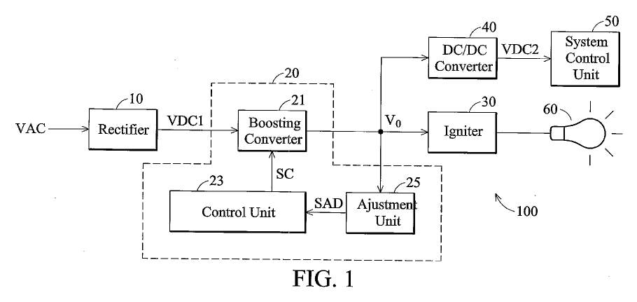

FIG. 1 shows an embodiment of a projector. As shown, a projector 100 comprises a rectifier 10, a power factor correction circuit 20, an igniter 30, a DC/DC converter 40 and a system control unit 50 and a lamp 60.

The rectifier 10 rectifies a system alternate-current (AC) power source, thereby outputting a rectified voltage V(t). For example, the rectifier 10 can be a full bridge rectifier, but is not limited thereto. In this embodiment, the rectified voltage V(t) output from the rectifier 10 comprises a voltage with ripple, and the amplitude of ripple depends on the capacitor C0 and/or time.

The power factor correction circuit 20 converts the rectified voltage V(t) into a DC output voltage Vo, such as 380 VDC, and supplies the igniter and the DC/DC converter 40. For example, the power factor correction circuit 20 can be an active power factor correction circuit. As shown, the power factor correction circuit 20 comprises a boosting converter 21, a control unit 23 and an adjustment unit 25.

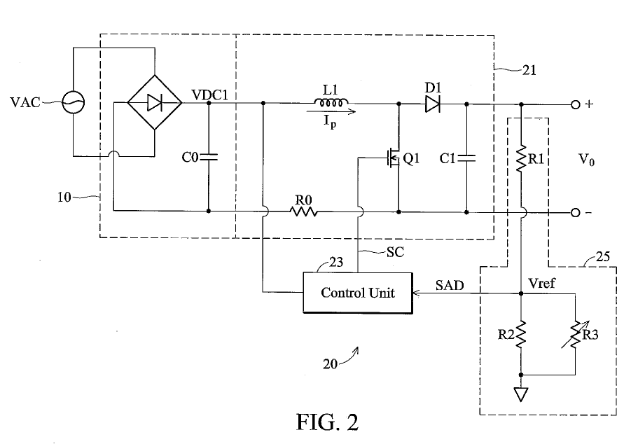

The boosting converter 21 converts the rectified voltage V(t) into the DC output voltage Vo. For example, the boosting converter 21 can comprise a switching element Q1 (shown in FIG. 2) controlled by the control unit 22 to adjust the DC output voltage Vo.

The control unit 23 controls a duty cycle of the switching element Q1 in the boosting converter 21 thereby adjusting the voltage difference between the DC output voltage Vo and the rectified voltage V(t) according to an adjustment signal SAD generated by the adjustment unit 25. For example, the control unit 23, according to the adjustment signal SAD, generates a control signal SC to shorten the duty cycle of the switching element Q1 thereby lowering the DC output voltage Vo, when temperature increases.

The adjustment unit 25 generates the adjustment signal SAD according to the present temperature and DC output voltage Vo. For example, the adjustment unit 25 can be voltage division circuit and comprises a thermister with a positive temperature coefficient (shown in FIG. 2).

The igniter lights the lamp 60 by the DC output voltage Vo generated by the power factor correction circuit 20 and maintains the power factor at a constant. For example, the igniter can be a ballast with an input voltage between 220 VDC and 400 VDC, but is not limited thereto. Namely, the igniter 30 can light the lamp 60 to illuminate while the DC output voltage Vo generated by the power factor correction circuit 20 falls within 220 VDC˜400 VDC.

The DC/DC converter 40 converts the DC output voltage Vo to a DC voltage VDC2, such as 12 VDC, 5 VDC or 3.3 VDC, for the system control unit 50. The system control unit 50 controls the operation of the whole projector 100.

FIG. 2 shows an embodiment of a power factor correction circuit. As shown, the boosting converter 21 comprises a resistor R0, an inductor L1, a switching element Q1 and a diode D1. The adjustment unit 25 is a voltage division circuit comprising resistors R1˜R3. The resistor R3 can be a thermister with a positive temperature coefficient and is disposed adjacent to pins of active elements with a large power loss, such as the inductor L1 or the switching element L1, during layout stage.

Further, the rectifier 10 executes a full wave rectifying to the system AC power source VAC and outputs the rectified voltage V(t). In this embodiment, the rectified voltage V(t) output from the rectifier 10 comprises a voltage with ripple, and the [symbol] of ripple depends on the capacitor C0 and/or time.

According to the circuit structure of the boosting converter 21, the relationship between the input voltage V(t) thereof and the output voltage Vo can be regarded as:

$$Vo = \frac{1}{( 1 - D ( t ) )} \times V ( t ) ,$$

wherein D(t) represents the duty cycle of the switching element Q1.

In view of this, increased DC output voltage Vo increases the number of duty cycles D(t) of the switching element Q1. However, with increased duty cycle of the switching element Q1, the current IP through the inductor L1 is larger, such that switching lost caused the switching element Q1 increases and element temperature thereof increases.

Generally, when the input voltage is changed to 100 VAC to 240 VAC, if the boosting converter 21 still maintains the DC output voltage Vo at 380 VDC, the duty cycle of the switching element Q1 should be large. Because there is a positive proportional relationship between the current IP through the inductor L1 and the duty cycle of the switching element Q1, switching lost caused the switching element Q1 increases, such that system efficiency degrades and element temperature increases.

To address this problem, the embodiment utilizes the adjustment unit 25 with the thermister with positive temperature coefficient to generate an adjustment signal SAD according to the present temperature and the DC output voltage Vo generated by the boosting converter 21. Further, the adjustment signal SAD is provided to the control unit 23 to control the duty cycle of the switching element Q1. Namely, when temperature of the boosting converter 21 is increased by switching lost of the switching element Q1, the control unit 23 generates a control signal SC to shorten the duty cycle of the switching element Q1, thereby lowering the current IP through the inductor L1 and the switching lost according to the adjustment signal SAD.

The adjustment unit 25 is coupled to the DC output voltage Vo from the boosting unit 12 to generate a division voltage Vref to serve as the adjustment signal SAD and output to the control unit 23. The relationship between the DC output voltage Vo and the voltage Vref can be regarded as:

Wherein, r1 represents resistance of the resistor R1, RS represents resistance of the resistance of the resistors R2 and R3 connected in parallel, such as, r2 represents resistance of resistor R2, and r3 represents resistance of resistor R3.

Because the resistor R2 (thermister) has a positive temperature coefficient and is disposed adjacent to the pins of the inductor L1 or the switching element Q1, the resistance of the resistor R3 increases and the resistance RS increases, such DC output voltage Vo is lowered. For example, the resistor R3 can be disposed adjacent to the first terminal or the second terminal of the inductor L1 or the switching element Q1. Hence, the control unit 23 shortens the duty cycle of the switching element Q1 according to the adjustment signal SAD generated by the adjustment unit 25, to lower the switching lost. Thus, the DC output voltage Vo generated by the boosting converter 21 and temperature can maintain a balance.

Because the igniter 30 is a ballast with an input voltage between 220 VDC and 400 VDC, the igniter 30 can light the lamp 60 to illuminate while the DC output voltage Vo generated by the power factor correction circuit 20 falls within 220 VDC˜400 VDC.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power factor correction circuit, comprising:
a boosting converter comprising a switching element and an inductor, converting a rectified voltage into a DC output voltage;
an adjustment unit comprising a thermister with positive temperature coefficient, generating an adjustment signal according to a present temperature and the DC output voltage; and
a control unit controlling a duty cycle of the switching element according to the adjustment signal, thereby adjusting the voltage difference between the rectified voltage and the DC output voltage.

2. The power factor correction circuit as claimed in claim 1, wherein the control unit, according to the adjustment signal, shortens the duty cycle of the switching element thereby lowering the DC output voltage when temperature of the switching element or the inductor increases.

3. The power factor correction circuit as claimed in claim 1, wherein the adjustment unit comprises:
a first resistor comprising a first terminal coupled to the DC output voltage and a second terminal;
a second resistor comprising a first terminal coupled to the second terminal of the first resistor and a second terminal coupled to a ground voltage; and
the thermister coupled to the second resistor in parallel, wherein a cross voltage between the first and second terminals of the second resistor serves as the adjustment signal.

4. The power factor correction circuit as claimed in claim 2, wherein the boosting converter comprises:
the inductor comprising a first terminal coupled to the rectified voltage and a second terminal;
the switching element comprising a first terminal coupled to the second terminal of the inductor and a control terminal coupled to the control unit;
a diode comprising an anode coupled to the inductor and the first terminal of the switching element and a cathode; and
a first capacitor coupled between the cathode of the diode and the ground voltage.

5. The power factor correction circuit as claimed in claim 4, wherein the thermister is disposed adjacent to the first terminal or the second terminal of the inductor.

6. The power factor correction circuit as claimed in claim 4, wherein the thermister is disposed adjacent to the first terminal or the second terminal of the switching element.

7. A power factor correction circuit, comprising:
a boosting converter comprising a switching element and an inductor, converting a rectified voltage into a DC output voltage according to a formulation of
$$Vo = \frac{1}{( 1 - D ( t ) )} \times V ( t ) ,$$
wherein V(t) represents the rectified voltage, Vo represents the DC output voltage and D(t) represents a duty cycle of the switching element;
a voltage division circuit comprising a thermister with positive temperature coefficient, generating an adjustment signal according to a present temperature and the DC output voltage; and
a control unit shortening the duty cycle of the switching element, thereby lowering the DC output voltage when the temperature of the switching element or the inductor increases, according to the adjustment signal.

8. The power factor correction circuit as claimed in claim 7, wherein the voltage division circuit comprises:
a first resistor comprising a first terminal coupled to the DC output voltage and a second terminal;
a second resistor comprising a first terminal coupled to the second terminal of the first resistor and a second terminal coupled to a ground voltage; and
the thermister coupled to the second resistor in parallel, wherein a cross voltage between the first and second terminals of the second resistor serves as the adjustment signal.

9. The power factor correction circuit as claimed in claim 7, wherein the boosting converter comprises:
the inductor comprising a first terminal coupled to the rectified voltage and a second terminal;
the switching element comprising a first terminal coupled to the second terminal of the inductor and a control terminal coupled to the control unit;
a diode comprising an anode coupled to the inductor and the first terminal of the switching element and a cathode; and
a first capacitor coupled between the cathode of the diode and the ground voltage.

10. The power factor correction circuit as claimed in claim 9, wherein the thermister is disposed adjacent to the first terminal or the second terminal of the inductor.

11. The power factor correction circuit as claimed in claim 9, wherein the thermister is disposed adjacent to the first terminal or the second terminal of the switching element.

12. A projector, comprising:
a rectifier coupled to an alternate current (AC) voltage, outputting a rectified voltage;
a power factor correction circuit comprising:
a boosting converter comprising a switching element and an inductor, converting the rectified voltage to a DC output voltage;
an adjustment unit comprising a thermister with positive temperature coefficient, generating an adjustment signal according to a present temperature and the DC output voltage; and
a control unit controlling a duty cycle of the switching element according to the adjustment signal, thereby adjusting the voltage difference between the rectified voltage and the DC output voltage;
a lamp; and
an igniter coupled to the DC output voltage, lighting the lamp.

13. The projector as claimed in claim 12, further comprising a DC/DC converter converting the DC output voltage to a second DC voltage for powering a system control unit, wherein the DC output voltage exceeds a peak of the rectified voltage, and the second DC voltage is lower than the DC output voltage.

14. The projector as claimed in claim 12, wherein the igniter is a ballast.

15. The projector as claimed in claim 12, wherein the wherein the adjustment unit comprises:
a first resistor comprising a first terminal coupled to the DC output voltage and a second terminal;
a second resistor comprising a first terminal coupled to the second terminal of the first resistor and a second terminal coupled to a ground voltage; and
the thermister coupled to the second resistor in parallel, wherein a cross voltage between the first and second terminals of the second resistor serves as the adjustment signal.

16. The projector as claimed in claim 12, wherein the boosting converter comprises:
the inductor comprising a first terminal coupled to the rectified voltage and a second terminal;
the switching element comprising a first terminal coupled to the second terminal of the inductor and a control terminal coupled to the control unit;
a diode comprising an anode coupled to the inductor and the first terminal of the switching element and a cathode; and
a first capacitor coupled between the cathode of the diode and the ground voltage.

17. The projector as claimed in claim 16, wherein the thermister is disposed adjacent to the first terminal or the second terminal of the inductor.

18. The projector as claimed in claim 16, wherein the thermister is disposed adjacent to the first terminal or the second terminal of the switching element.

19. A projector, comprising:
a rectifier coupled to an alternate current (AC) voltage, outputting a rectified voltage;
a power factor correction circuit comprising:
a boosting converter comprising a switching element and an inductor, converting the rectified voltage into a DC output voltage according to a formulation of
$$Vo = \frac{1}{( 1 - D ( t ) )} \times V ( t ) ,$$
wherein V(t) represents the rectified voltage, Vo represents the DC output voltage and D(t) represents a duty cycle of the switching element;
a voltage division circuit comprising a thermister with positive temperature coefficient, generating an adjustment signal according to a present temperature and the DC output voltage; and
a control unit shortening the duty cycle of the switching element, thereby lowering the DC output voltage when the temperature of the switching element or the inductor increases, according to the adjustment signal;
a lamp; and
an igniter coupled to the DC output voltage, to light the lamp.

20. The projector as claimed in claim 19, wherein the boosting converter comprises:
the inductor comprising a first terminal coupled to the rectified voltage and a second terminal;
the switching element comprising a first terminal coupled to the second terminal of the inductor and a control terminal coupled to the control unit;
a diode comprising an anode coupled to the inductor and the first terminal of the switching element and a cathode; and
a first capacitor coupled between the cathode of the diode and the ground voltage.

21. The projector as claimed in claim 20, wherein the thermister is disposed adjacent to the first terminal or the second terminal of the inductor.

22. The projector as claimed in claim 20, wherein the thermister is disposed adjacent to the first terminal or the second terminal of the switching element.

23. The projector as claimed in claim 19, wherein the voltage division circuit comprises:
a first resistor comprising a first terminal coupled to the DC output voltage and a second terminal;
a second resistor comprising a first terminal coupled to the second terminal of the first resistor and a second terminal coupled to a ground voltage; and
the thermister coupled to the second resistor in parallel, wherein a cross voltage between the first and second terminals of the second resistor serves as the adjustment signal.
